(19) United States
(12) Patent Application Publication
(10) Pub. No.: US 2013/0134618 A1
(43) Pub. Date: May 30, 2013

(54) PROCESS FOR PRODUCING A MOLDED PRODUCT

(71) Applicant: Kevin G. Kangas, Hixson, TN (US)

(72) Inventor: Kevin G. Kangas, Hixson, TN (US)

(73) Assignee: WOODBRIDGE CORPORATION, Brodhead, WI (US)

(21) Appl. No.: 13/701,778

(22) PCT Filed: Jun. 6, 2011
(86) PCT No.: PCT/US2011/039271

§ 371 Date: Feb. 13, 2013

Related U.S. Application Data
(60) Provisional application No. 61/351,464, filed on Jun. 4, 2010.

(51) Int. Cl. B29C 41/28

(52) U.S. Cl. CPC B29C 41/28
USPC 264/171.13; 425/130

(57) ABSTRACT

There is described a process for producing a molded product. The process comprises the steps of: (i) dispensing a molding material on a first molding belt comprising a first polymer layer; (ii) contacting the molding material with a second molding belt comprising a second polymer layer; and (iii) shaping the molding material between the first molding belt and the second molding belt to produce the molded product. A system for producing a molded product is also described.

### CROSS-REFERENCE TO RELATED APPLICATION

The present application claims the benefit under 35 U.S.C. §119(e) of provisional patent application Ser. No. 61/351,464, filed Jun. 4, 2010, the contents of which are hereby incorporated by reference.

### FIELD OF THE INVENTION

In one of its aspects, the present invention relates to a process for producing a molded product. In another of its aspects, the present invention relates to a system for producing a molded product.

DESCRIPTION OF THE PRIOR ART

It is known in the art to produce in a continuous manner a molded product using a so-called belt mold.

A conventional belt mold has a pair of general opposed moving belts. A molding material (e.g., a polymer-based material such as polyurethane and the like) is dispensed between the belts and the belts in combination are used to shape and form the finished dimensions of the molded product as it cures on the belt mold. Production is continuous insofar as the belts are moved as molding material is continually dispensed on one of the belts.

Given that, in many cases, the molding composition is somewhat adhesive in nature until it is cured, it is known in the art to use a so-called mold release agent on the belts to facilitate removal of the molded product after it has been cured.

The use of such mold release agents is disadvantageous for a number of reasons. First, the use of such mold release agents adds to the overall cost of production of the molded product. Second, the use of such mold release agents results in the need to periodically clean the belt mold to maintain proper operation thereof resulting in reduced overall efficiency. Third, the use of such mold release agents can, in certain cases, cause damage to the belt mold. Fourth, the use of mold release agents can result in higher incidence of production of scrap parts.

Additional details on belt molds known in the art and the operation thereof may be found on one or more of the following documents:

U.S. Pat. No. 3,914,084 [Kornylak];

U.S. Pat. No. 4,230,649 [Bohm et al.];

U.S. Pat. No. 5,089,189 [Staneluis et al.]; and

U.S. Pat. No. 5,966,665 [Poisson]

Given the above, it would be desirable to have a process and a system for producing a molded product in a belt mold which avoids the requirement to use the above-mentioned mold release agents. Additionally, it would be beneficial to have such a process and system which is capable of conferring to the molded product a pre-determined textured finish surface. It would be desirable to be able to achieve this using existing belt mold systems thereby obviating the need to for significant additional capital expense.

### SUMMARY OF THE INVENTION

It is an object of the present invention to obviate or mitigate at least one of the above-mentioned disadvantages of the prior art.

It is another object of the present invention to provide a novel process for producing a molded product.

It is another object of the present invention to provide a novel system for producing a molded product.

Accordingly, in one of its aspects, the present invention provides a process for producing a molded product comprising the steps of:

(i) dispensing a molding material on a first molding belt comprising a first polymer layer;

(ii) contacting the molding material with a second molding belt comprising a second polymer layer; and (iii) shaping the molding material between the first molding belt and the second molding belt to produce the molded product.

In another of its aspects, the present invention provides a system for producing a molded product comprising:

a first molding belt and a second molding belt disposed substantially opposed to one another;

(ii) a first polymer layer dispensing element configured to place a first polymer layer on the first molding belt;

(iii) a first polymer layer removal element configured to remove the first polymer layer from the first molding belt;

(iv) a second polymer layer dispensing element configured to place a second polymer layer on the second molding belt;

(v) a second polymer layer removal element configured to remove the second polymer layer from the second molding belt.

Thus, the present inventor has discovered a novel process and system for producing a molded product. In the present process an system, the need to utilize the above-mentioned mold release agents is mitigated or obviated through the use of polymer layers on the belt mold to separate the molding composition from the moving belts. Each polymer layer is preferably applied just prior to dispensing the molding composition on the belt mold and, in certain preferred embodiments (e.g., when it is desired to subject the molded product to a subsequent painting step) is removed from the belt mold immediately after molding is complete. In other embodiments, it is possible to retain the one or both of the polymer layers on the molded product. When a polymer layer having a combination of tensile strength, elongation at break and thickness is used, it is possible to stretch the polymer layer so that it appears to be “painted” on the molding belt—this is a highly advantageous feature of the present process.

The use of such polymer layers results in a number of advantageous. First, it obviates or mitigates labour associated with cleaning of the belt mold resulting from the use of the above-mentioned mold release agents. Second, the life of the belt in the belt mold is significantly extended. Third, the molded product quality is improved thereby reducing the production of scrap in the process. Fourth, there is increased production efficiency (e.g., since the need to clean the belt mold is obviated or mitigated). Fifth, the cost associated with the use of the above-mentioned mold release agents is obviated or mitigated. Sixth, it is possible to implement the present process in an existing belt mold without the need for significant additional capital expense. Seventh, by using polymer layers having a textured surface (e.g., polymer layers containing a particulate material which augments addition of roughness to and/or reduction of gloss from the surface of the molded product), it is possible to readily produce a molded product having a textured surface. Eighth, when a polymer layer having a combination of tensile strength, elongation at break and thickness is used, it is possible to transfer texture from one or both molding belts to the molded product. Ninth, in certain cases, it is possible to reuse the polymer layer thereby improving the overall efficiency of the process.

The present process can be used to produce a molded product based on, for example, a polymer material. The molded product may be cellular or non-cellular in nature. The polymer material may be based on, for example, polyurethane which may be filled (e.g., particles, fibres, etc.) or unfilled.

### BRIEF DESCRIPTION OF THE DRAWINGS

Embodiments of the present invention will be described with reference to the accompanying drawing in which:

FIG. 1 illustrates a schematic view of a preferred embodiment of the present process and system; and

FIG. 2 illustrates a schematic view of an alternate preferred embodiment of the present process and system.

### DETAILED DESCRIPTION OF THE PREFERRED EMBODIMENTS

In one of its aspects, the present invention relates to a process for producing a molded product. Preferred embodiments of the process may include any one or a combination of any two or more of any of the following features:
prior to Step (i), the first polymer layer is placed on the first molding belt;
the process comprises dispensing the first polymer layer on to the first molding belt from a first leading roll operated to maintain a first stress on the first polymer layer;
the first stress is in the range of from about 200 lb/in² to about 2000 lb/in²;
the first stress is in the range of from about 500 lb/in² to about 1000 lb/in²;
the process comprises the further step of adjusting a torque of the first leading roll as a diameter of the first leading roll changes to substantially maintain the first stress on the first polymer layer;
after Step (iii), the first polymer layer is removed from the first molding belt;
the process comprises transferring the first polymer layer from the first molding belt to a first trailing roll operated to maintain a second stress on the first polymer layer;
the second stress is in the range of from about 100 lb/in² to about 1000 lb/in²;
the second stress is in the range of from about 200 lb/in² to about 500 lb/in²;
the process comprises the further step of adjusting a torque of the first trailing roll as a diameter of the first trailing roll changes;
prior to Step (i), the second polymer layer is placed on the second molding belt;
the process comprises dispensing the second polymer layer on to the second molding belt from a second leading roll operated to maintain a first stress on the second polymer layer;
the second stress is in the range of from about 200 lb/in² to about 2000 lb/in²;
the second stress is in the range of from about 500 lb/in² to about 1000 lb/in²;
the process comprises the further step of adjusting a torque of the second leading roll as a diameter of the second leading roll changes to substantially maintain the first stress on the second polymer layer;
after Step (iii), the second polymer layer is removed from the second molding belt;
the process comprises transferring the second polymer layer from the second molding belt to a second trailing roll operated to maintain a second stress on the second polymer layer;
the second stress is in the range of from about 100 lb/in² to about 1000 lb/in²;

the second stress is in the range of from about 200 lb/in² to about 500 lb/in²;
the process comprises the further step of adjusting a torque of the second trailing roll as a diameter of the second trailing roll changes;
during Step (iii), the first molding belt is moved at a first speed;
the first speed is selected from 0.001 ft/min to about 200 ft/min;
the first speed is selected from 5 ft/min to about 50 ft/min;
the first speed is selected from 12 ft/min to about 30 ft/min;
during Step (iii), the second molding belt is moved at a second speed;
second speed is selected from 0.001 ft/min to about 200 ft/min;
the second speed is selected from 5 ft/min to about 50 ft/min;
the second speed is selected from 12 ft/min to about 30 ft/min;
during Step (iii), each of the first molding belt and the second molding belt is moved at a substantially common speed;
the substantially common speed is selected from 0.001 ft/min to about 200 ft/min;
the substantially common speed is selected from 5 ft/min to about 50 ft/min;
the substantially common speed is selected from 12 ft/min to about 30 ft/min;
one or both of the first polymer layer and the second polymer layer is a polyolefin;
both of the first polymer layer and the second polymer layer is a polyolefin which may be the same or different;
the polyolefin comprises a homopolymer, a copolymer or a terpolymer derived from the polymerization of at least one olefin monomer;
the at least one olefin monomer is selected from the group comprising ethylene, α-olefin monomers, diolefin monomers and polymerizable monomers containing at least one internal olefin linkage;
the polyolefin comprises a homopolymer based on ethylene or an α-olefin monomer;
the olefin monomer comprises an α-olefin monomer;
the α-olefin monomer is selected from the group comprising propylene, 1-butene, isobutene, 1-pentene, 1-hexene, 1-octene, branched isomers thereof, styrene, α-methylstyrene and mixtures thereof
the α-olefin monomer comprises propylene;
the olefin monomer comprises a diolefin monomer;
the diolefin monomer comprises an aliphatic compound;
the diolefin monomer is selected from the group consisting of 1,3-butadiene, isoprene, 2,3-dimethyl-1,3-butadiene, 2-ethyl-1,3-butadiene, piperylene, myrcene, allene, 1,2-butadiene, 1,4,9-decatrienes, 1,4-hexadiene, 1,6-octadiene, 1,5-hexadiene, 4-methyl-1,4-hexadiene, 5-methyl-1,4-hexadiene, 7-methyl-1,6-octadiene, phenylbutadiene, pentadiene and mixtures thereof;
the diolefin monomer comprises a bicyclic compound;
the diolefin monomer is selected from the group comprising norbornadiene, alkyl derivatives thereof, 5-alkylidene-2-norbornene compounds, 5-alkenyl-2-norbornene compounds and mixtures thereof;
the diolefin monomer is selected from the group comprising 5-methylene-2-norbornene, 5-ethylidene-2-norbornene, 5-propenyl-2-norbornene and mixtures thereof;
the diolefin monomer is selected from the group comprising 1,4-cyclohexadiene, 1,5-cyclooctadiene, 1,5-cyclododecadiene, methyltetrahydroindene, dicyclopentadiene, bicyclo[2.2.1]hepta-2,5-2,5-diene and mixtures thereof;
the polyolefin is a copolymer derived from polymerization of a mixture of ethylene and at least one α-olefin;
the polyolefin is a copolymer derived from polymerization of a mixture of ethylene and propylene;
the mixture comprises from about 30 to about 75 ethylene and from about 25 to about 70 weight percent α-olefin;
the mixture comprises from about 35 to about 65 ethylene and from about 35 to about 65 weight percent α-olefin;
the polyolefin is a copolymer derived from polymerization of a mixture of ethylene, at least one α-olefin and at least one diolefin monomer;
the polyolefin is a copolymer derived from polymerization of a mixture of ethylene, propylene and one or both of 5-ethylidene-2-norbornene and 1,5-hexadiene;
the first polymer layer has a thickness in the range of from about 0.5 mil to about 30 mil;
the first polymer layer has a thickness in the range of from about 0.5 mil to about 10 mil;
the first polymer layer has a thickness in the range of from about 0.7 mil to about 1.2 mil;
the second polymer layer has a thickness in the range of from about 0.5 mil to about 30 mil;
the second polymer layer has a thickness in the range of from about 0.5 mil to about 10 mil;
the second polymer layer has a thickness in the range of from about 0.7 mil to about 1.2 mil;
the first polymer layer and the second polymer layer have the same or different thickness, the thickness being in the range in the range of from about 0.5 mil to about 30 mil;
the first polymer layer and the second polymer layer have the same or different thickness, the thickness being in the range in the range of from about 0.5 mil to about 10 mil;
the first polymer layer and the second polymer layer have the same or different thickness, the thickness being in the range in the range of from about 0.7 mil to about 1.2 mil;
the first polymer layer has a tensile strength in the range of from about 2000 psi to about 2500 psi;
the second polymer layer has a tensile strength in the range of from about 2000 psi to about 2500 psi;
the first polymer layer and the second polymer layer have the same or different tensile strength, the tensile strength being in the range of from about 2000 psi to about 2500 psi;
the first polymer layer has an elongation at break in the range of from about 300% to about 600%;
the second polymer layer has an elongation at break in the range of from about 450% to about 550%;
the second polymer layer has an elongation at break in the range of from about 300% to about 600%;
the second polymer layer has an elongation at break in the range of from about 450% to about 550%;
the first polymer layer and the second polymer layer have the same or different elongation at break, the elongation at break being in the range of from about 300% to about 600%;
the first polymer layer and the second polymer layer have the same or different elongation at break, the elongation at break being in the range of from about 450% to about 550%;
one or both of the first polymer layer and the second polymer layer comprises a filler material to provide a textured surface; and/or
one or both of the first polymer layer and the second polymer layer comprises a textured surface for contact with the molding material.

In one of its aspects, the present invention relates to a system for producing a molded product. Preferred embodiments of the system may include any one or a combination of any two or more of any of the following features:
the first polymer layer dispensing element comprises a roller element;
the second polymer layer dispensing element comprises a roller element;
the first polymer layer removal element comprises a roller element;
the second polymer layer removal element comprises a roller element;
the first polymer layer dispensing element is configured to be operated to maintain a first stress on the first polymer layer;
the first stress is in the range of from about 200 lb/in² to about 2000 lb/in²;
the first stress is in the range of from about 500 lb/in² to about 1000 lb/in²;
the first polymer layer dispensing element is configured to adjust a torque thereof as a diameter of the first polymer layer dispensing element changes to substantially maintain the first stress on the first polymer layer;
the first polymer layer removal element is configured to be operated to maintain a second stress on the first polymer layer;
the first stress is in the range of from about 100 lb/in² to about 1000 lb/in²;
the first stress is in the range of from about 200 lb/in² to about 500 lb/in²;
the first polymer layer removal element is configured to adjust a torque thereof as a diameter of the first polymer layer removal element changes;
the second polymer layer dispensing element is configured to maintain a first stress on the second polymer layer;
the first stress is in the range of from about 200 lb/in² to about 2000 lb/in²;
the first stress is in the range of from about 500 lb/in² to about 1000 lb/in²;
the second polymer layer dispensing element is configured to adjust a torque thereof as a diameter of the second polymer layer dispensing element changes to substantially maintain the first stress on the second polymer layer;
the second polymer layer removal unit is configured to be operated to maintain a second stress on the second polymer layer;
the second stress is in the range of from about 100 lb/in² to about 1000 lb/in²;
the second stress is in the range of from about 200 lb/in² to about 500 lb/in²;
the second polymer layer removal unit is configured to adjust a torque thereof as a diameter of the second polymer layer removal unit changes;
the first molding belt is configured to be moved at a first speed;
the first speed is selected from 0.001 ft/min to about 200 ft/min;
the first speed is selected from 5 ft/min to about 50 ft/min;
the first speed is selected from 12 ft/min to about 30 ft/min;
the second molding belt is configured to be moved at a second speed;
the second speed is selected from 0.001 ft/min to about 200 ft/min;
the second speed is selected from 5 ft/min to about 50 ft/min;
the second speed is selected from 12 ft/min to about 30 ft/min;
the first molding belt and the second molding belt is moved at a substantially common speed;
the substantially common speed is selected from 0.001 ft/min to about 200 ft/min;
the substantially common speed is selected from 5 ft/min to about 50 ft/min;
the substantially common speed is selected from 12 ft/min to about 30 ft/min;
one or both of the first polymer layer and the second polymer layer is a polyolefin;
both of the first polymer layer and the second polymer layer is a polyolefin which may be the same or different;
the polyolefin comprises a homopolymer, a copolymer or a terpolymer derived from the polymerization of at least one olefin monomer;
the at least one olefin monomer is selected from the group comprising ethylene, α-olefin monomers, diolefin monomers and polymerizable monomers containing at least one internal olefin linkage;
the polyolefin comprises a homopolymer based on ethylene or an α-olefin monomer;
the olefin monomer comprises an α-olefin monomer;
the α-olefin monomer is selected from the group comprising propylene, 1-butene, isobutene, 1-pentene, 1-hexene, 1-octene, branched isomers thereof, styrene, α-methylstyrene and mixtures thereof;
the α-olefin monomer comprises propylene;
the olefin monomer comprises a diolefin monomer;
the diolefin monomer comprises an aliphatic compound;
the diolefin monomer is selected from the group consisting of 1,3-butadiene, isoprene, 2,3-dimethyl-1,3-butadiene, 2-ethyl-1,3-butadiene, piperylene, myrcene, allene, 1,2-butadiene, 1,4,9-decatrienes, 1,4-hexadiene, 1,6-octadiene, 1,5-hexadiene, 4-methyl-1,4-hexadiene, 5-methyl-1,4-hexadiene, 7-methyl-1,6-octadiene, phenylbutadiene, pentadiene and mixtures thereof;
the diolefin monomer comprises a bicyclic compound;
the diolefin monomer is selected from the group comprising norbornadiene, alkyl derivatives thereof, 5-alkylidene-2-norbornene compounds, 5-alkenyl-2-norbornene compounds and mixtures thereof;
the diolefin monomer is selected from the group comprising 5-methylene-2-norbornene, 5-ethylidene-2-norbornene, 5-propenyl-2-norbornene and mixtures thereof;
the diolefin monomer is selected from the group comprising 1,4-cyclohexadiene, 1,5-cyclooctadiene, 1,5-cyclododecadiene, methyltetrahydroindene, dicyclopentadiene, bicyclo[2.2.1]hepta-2,5-2,5-diene and mixtures thereof;
the polyolefin is a copolymer derived from polymerization of a mixture of ethylene and at least one α-olefin;
the polyolefin is a copolymer derived from polymerization of a mixture of ethylene and propylene;
the mixture comprises from about 30 to about 75 ethylene and from about 25 to about 70 weight percent α-olefin;
the mixture comprises from about 35 to about 65 ethylene and from about 35 to about 65 weight percent α-olefin;
the polyolefin is a copolymer derived from polymerization of a mixture of ethylene, at least one α-olefin and at least one diolefin monomer;
the polyolefin is a copolymer derived from polymerization of a mixture of ethylene, propylene and one or both of 5-ethylidene-2-norbornene and 1,5-hexadiene;
the first polymer layer has a thickness in the range of from about 0.5 mil to about 30 mil;
the first polymer layer has a thickness in the range of from about 0.5 mil to about 10 mil;
the first polymer layer has a thickness in the range of from about 0.7 mil to about 1.2 mil;
the second polymer layer has a thickness in the range of from about 0.5 mil to about 30 mil;
the second polymer layer has a thickness in the range of from about 0.5 mil to about 10 mil;
the second polymer layer has a thickness in the range of from about 0.7 mil to about 1.2 mil;
the first polymer layer and the second polymer layer have the same or different thickness, the thickness being in the range in the range of from about 0.5 mil to about 30 mil;
the first polymer layer and the second polymer layer have the same or different thickness, the thickness being in the range in the range of from about 0.5 mil to about 10 mil;
the first polymer layer and the second polymer layer have the same or different thickness, the thickness being in the range in the range of from about 0.7 mil to about 1.2 mil;
the first polymer layer has a tensile strength in the range of from about 2000 psi to about 2500 psi;
the second polymer layer has a tensile strength in the range of from about 2000 psi to about 2500 psi;
the first polymer layer and the second polymer layer have the same or different tensile strength, the tensile strength being in the range of from about 2000 psi to about 2500 psi;
the first polymer layer has an elongation at break in the range of from about 300% to about 600%;
the second polymer layer has an elongation at break in the range of from about 450% to about 550%;
the second polymer layer has an elongation at break in the range of from about 300% to about 600%;
the second polymer layer has an elongation at break in the range of from about 450% to about 550%;
the first polymer layer and the second polymer layer have the same or different elongation at break, the elongation at break being in the range of from about 300% to about 600%;
the first polymer layer and the second polymer layer have the same or different elongation at break, the elongation at break being in the range of from about 450% to about 550%;
one or both of the first polymer layer and the second polymer layer comprises a filler material to provide a textured surface; and/or
one or both of the first polymer layer and the second polymer layer comprises a textured surface for contact with the molding material.

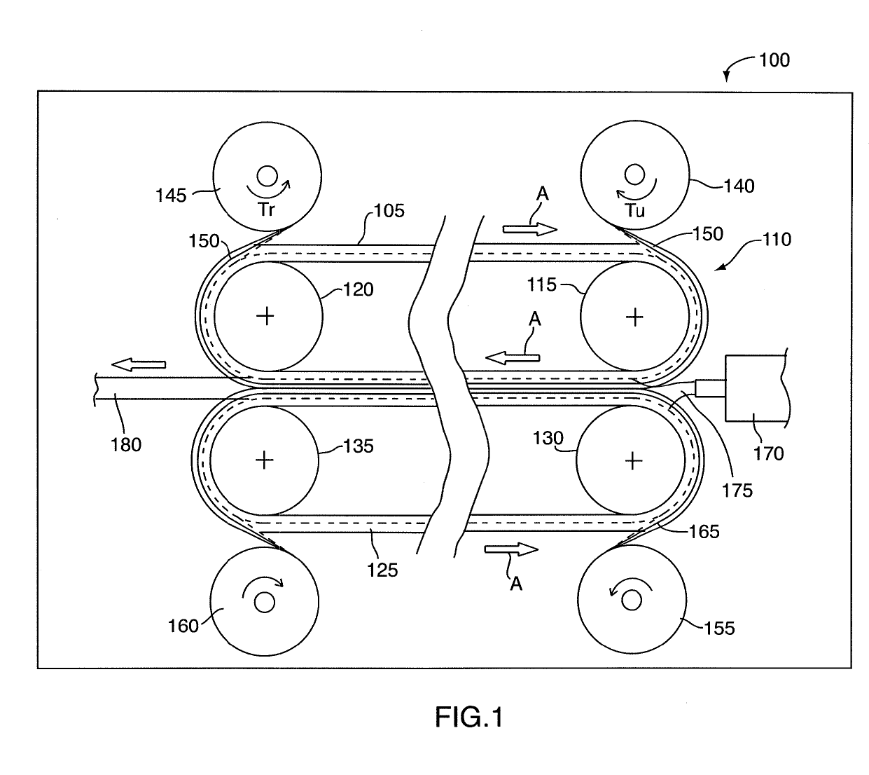

With reference to FIG. 1, there is illustrated a system 100 for producing a molded product. System 100 comprises a belt mold 110.

Belt mold 110 comprises an upper belt 105 configured to move in the direction of arrows A by a pair of belt rollers 115,120.

Belt mold 110 further comprises a belt 125 movable in the direction of arrow A by a pair of belt rollers 130,135.

System 100 further comprises an upper leading roll 140 and an upper trailing roll 145. As shown, upper leading roll 140 can be operated to unroll a polymer layer 150 on to upper belt 105 whereas trailing upper roll 145 is configured to operate to remove polymer layer 150 from belt 105.

Similarly, system 100 further comprises a lower leading roll 155 and a lower trailing roll 160. A polymer layer 165 is unrolled from lower leading roll 155 on to belt 125 whereas polymer 165 is removed from belt 105 by operation of lower trailing roll 160.

System 100 further comprises an extruder 170 which dispenses a molding material 175 between belts 105,125.

In operation, belt rollers 115,120 are operated to move belt 105 in the direction of arrows A and belt rollers 130,135 are operated to move belt 125 in the direction of arrows A. The movement of belt 105 causes polymer layer 150 to unroll from upper leading roll 140 while the movement of belt 125 causes polymer layer 165 to unroll from lower leading roll 155. This action causes a polymer layer to cover both belts in belt mold 110. As this is occurring, molding material 175 is dispensed primarily on polymer layer 165 which is on belt 125. As the molding material is moved by belt 125, it is contacted by polymer layer 150 which is on belt 105.

The continuous movement of belts 105,125 serves to shape and form a product 180. As product 180 eminates from belt mold 110, polymer layer 150 is removed from belt 105 on to upper trailing roll 145. Similarly, polymer layer 165 is removed belt 125 by lower trailing roll 160.

The leading rolls may be operated to produce the stresses on polymer layers 150 and/or 160 as described above. The trailing rolls may be operated to produce the stresses on polymer layers 150 and/or 160 as described above.

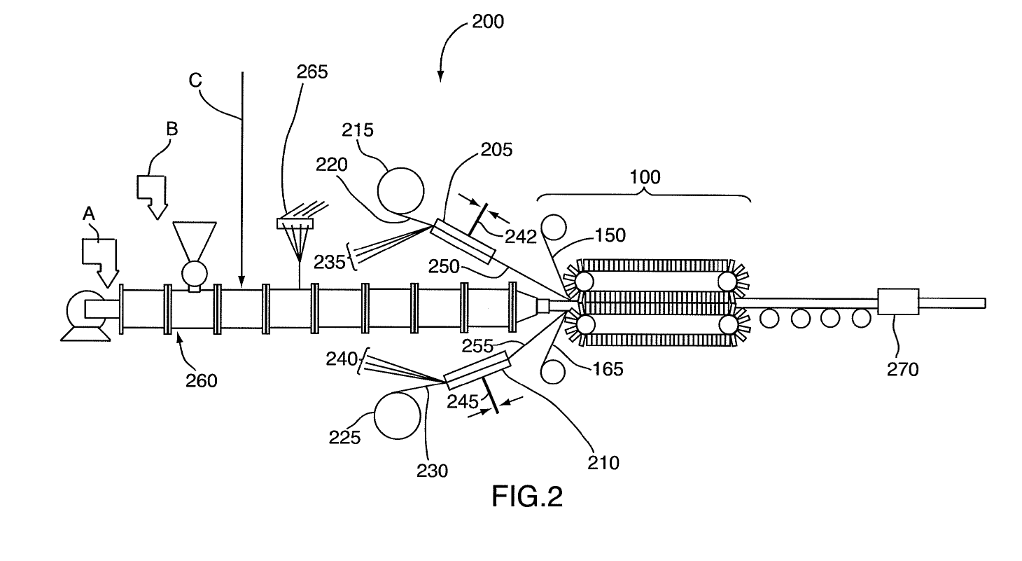

With reference to FIG. 2, in a particularly preferred embodiment of the present process, a pultrusion layer is applied between one or both of: (i) the first polymer layer and the molding material, and (ii) the second polymer layer and the molding material.

As is known in the art, a pultrusion process typically includes racks or creels holding rolls of fiber mat or doffs of fiber roving. Most often the reinforcement is fiberglass, but it can also be carbon, aramid or a mixture of any of these. This raw fiber is pulled off the racks and guided through a resin bath or resin impregnation system. Resin can also be injected directly into the die in some pultrusion systems.

The raw resin preferably a thermosetting resin, and and may be combined with fillers, catalysts and pigments. The fiber reinforcement becomes impregnated (wetted-out) with the resin such that all the fiber filaments are substantially completely saturated with the resin mixture.

As the resin rich fiber exits the resin impregnation system, the un-cured composite material is guided through a series of tooling that helps arrange and organize the fiber into the correct shape, while excess resin is squeezed out—this also known as “debulking”. This tooling is known in art as a “pre-former”. Often continuous strand mat and surface veils (polyethylene veil) are added in this step to increase structure and surface finish.

Thus, the pultrusion layer(s) may comprise a reinforcing layer that has been wetted with a polymer layer. The preferred reinforcing layer for use in the context of the present process is fibreglass, preferably in the form of fibreglass roving. The polymer layer may be selected from the group consisting of polyurethane polyesters, polyamides, epoxides, acrylics, silicones, phenolics and polymers based on other like non-volatile liquid monomers. The preferred polymer for use in the pultrusion layer(s) is polyurethane.

In this particularly preferred embodiment of the present process the molding material may be fill or unfilled. Suitable fillers include fly ash, calcium carbonate, alumina trihydrate, mica, calcium sulfate, talc, calcium silicate, silica and other like, relatively inexpensive organic and inorganic materials.

With reference to FIG. 2, there is shown a schematic of a system 200 for carrying out the above-mentioned particularly preferred embodiment of the present process. As shown, system 200 includes, schematically, system 100 described above with reference to FIG. 1.

Upstream of system 100 are a pair of pultrusion units 205,210. Upstream of pultrusion unit 205 is a roller 215 which feeds a polyethylene veil 220 to pultrusion unit 205. Upstream of pultrusion unit 210 is a roller 225 which feeds a polyethylene veil 230 to pultrusion unit 210.

One or more fibreglass mats or roving layers 235 are fed to pultrusion unit 205 in a conventional manner. One or more fibreglass mats or roving layers 240 are fed to pultrusion unit 210.

In a preferred embodiment, a polyurethane resin is used to impregnate or “wet out” the combination of polyethylene veil 220 and fibrerglass mats(s) 235 in pultrusion unit 205. This is achieved through an injector or similar device 242 in which a polyol and an isocyanate are each injected. A similar injector 245 is comprised in pultrusion unit 210 to add the polyurethane chemicals to the combination of polyethylene veil 230 and fibreglass mats(s) 240.

Thus, a pultruted layer 250 emanates from pultrusion unit 205 and a pultrusion layer 255 emanates from pultrusion unit 210. As shown in FIG. 2, pultrusion layer 250 is applied between polymer layer 150 of system 100 and the molding material (not shown for clarity in FIG. 2). Similarly, pultrusion layer 255 is applied between polymer layer 165 of system 100 and the molding material (again not shown for clarity).

The molding material used in system 200 shown in FIG. 2 may be as described above. In a preferred embodiment, the molding material is a polyurethane that is filled with fly ash and optionally filled with particulate fibreglass in a reactor 260. Thus, polyol may be added via arrow A and a filler such as fly ash may be added via an arrow B. Particulate fibreglass may be added as an optional component at a station 265 downstream of addition of the polyol and filler. An isocyanate may be added via arrow C.

The resulting molding composition is fed between pultrusion layers 250,255 in system 100 which is operated as described above.

In a preferred embodiment, the molded laminate material emanating from system 100 is sent to a painting station 270 where a paint such an ultraviolet radiation resistant paint may be applied.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

1. A process for producing a molded product comprising the steps of:
(i) dispensing a molding material on a first molding belt comprising a first polymer layer;
(ii) contacting the molding material with a second molding belt comprising a second polymer layer; and
(iii) shaping the molding material between the first molding belt and the second molding belt to produce the molded product.

2. The process defined in claim 1, wherein, prior to Step (i), the first polymer layer is placed on the first molding belt.

3. The process defined in claim 2, comprising dispensing the first polymer layer on to the first molding belt from a first leading roll operated to maintain a first stress on the first polymer layer.

4. The process defined in claim 3, wherein the first stress is in the range of from about 200 lb/in² to about 2000 lb/in².

5. The process defined in claim 3, wherein the first stress is in the range of from about 500 lb/in² to about 1000 lb/in².

6. The process defined in claim 3, comprising the further step of adjusting a torque of first leading roll as a diameter of the first leading roll changes to substantially maintain the first stress on the first polymer layer.

7. The process defined in claim 1, wherein, after Step (iii), the first polymer layer is removed from the first molding belt.

8. The process defined in claim 7, comprising transferring the first polymer layer from the first molding belt to a first trailing roll operated to maintain a second stress on the first polymer layer.

9. The process defined in claim 8, wherein the second stress is in the range of from about 100 lb/in² to about 1000 lb/in².

10. The process defined in claim 8, wherein the second stress is in the range of from about 200 lb/in² to about 500 lb/in².

11. The process defined in claim 8, comprising the further step of adjusting a torque of the first trailing roll as a diameter of the first trailing roll changes.

12. The process defined in claim 1, wherein, prior to Step (i), the second polymer layer is placed on the second molding belt.

13. The process defined in claim 12, comprising dispensing the second polymer layer on to the second molding belt from a second leading roll operated to maintain a first stress on the second polymer layer.

14. The process defined in claim 13, wherein the first stress is in the range of from about 200 lb/in² to about 2000 lb/in².

15. The process defined in claim 13, wherein the first stress is in the range of from about 500 lb/in² to about 1000 lb/in².

16. The process defined in claim 13, comprising the further step of adjusting the a torque of the second leading roll as a diameter of the second leading roll changes to substantially maintain the first stress on the second polymer layer.

17. The process defined in claim 1, wherein, after Step (iii), the second polymer layer is removed from the second molding belt.

18. The process defined in claim 17, comprising transferring the second polymer layer from the second molding belt to a second trailing roll operated to maintain a second stress on the second polymer layer.

19. The process defined in claim 18, wherein the second stress is in the range of from about 100 lb/in² to about 1000 lb/in².

20. The process defined in claim 18, wherein the second stress is in the range of from about 200 lb/in² to about 500 lb/in².

21. The process defined in claim 18, comprising the further step of adjusting a torque of the second trailing roll as a diameter of the second trailing roll changes.

22-33. (canceled)

34. The process defined in claim 1, 33wherein one or both of the first polymer layer and the second polymer layer is a polyolefin.

35-61. (canceled)

62. A system for producing a molded product comprising:
a first molding belt and a second molding belt disposed substantially opposed to one another;
(ii) a first polymer layer dispensing element configured to place a first polymer layer on the first molding belt;
(iii) a first polymer layer removal element configured to remove the first polymer layer from the first molding belt;
(iv) a second polymer layer dispensing element configured to place a second polymer layer on the second molding belt;
(v) a second polymer layer removal element configured to remove the second polymer layer from the second molding belt.

63-122. (canceled)
